(19) United States
(12) Patent Application Publication
(10) Pub. No.: US 2008/0069517 A1
(43) Pub. Date: Mar. 20, 2008

(54) BROADCAST PROGRAM RECORDING/PLAYBACK APPARATUS, BROADCAST PROGRAM PLAYBACK POSITION CONTROL METHOD, AND BROADCAST PROGRAM INFORMATION PROVIDING APPARATUS

(76) Inventors: Toshifumi Arai, Yokohama (JP); Kazushige Hiroi, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/844,392

(22) Filed: Aug. 24, 2007

(30) Foreign Application Priority Data
Sep. 20, 2006 (JP) 2006-254218

(51) Int. Cl. H04N 5/91

(52) U.S. Cl. 386/69; 386/46; 725/56

(57) ABSTRACT

There is provided a broadcast program recording/playback apparatus that starts playback of a recorded broadcast program from a desired scene, so that a user can specify a precise position of a desired scene in a recorded broadcast program and start playback. The apparatus comprises a recording control unit and a playback control unit. The playback control unit obtains information for feature data belonging to a referential feature frame and a relative time difference between the feature frame and an objective frame including the desired scene as position specifying data for determining the desired scene position. The playback control unit searches for the feature frame having the feature data from recorded broadcast program data, determines the objective frame position by adding the relative time difference to the position of the feature frame searched out, and controls to start playback from the determined objective frame position.

### CLAIM OF PRIORITY

The present application claims priority from Japanese application JP2006-254218 filed on Sep. 20, 2006, the content of which is hereby incorporated by reference into this application.

### BACKGROUND OF THE INVENTION

The technical field of the invention relates to a broadcast program recording/playback apparatus, a broadcast program playback position control method, and a broadcast program information providing apparatus for starting playback of a broadcast program recorded beforehand from the beginning of a desired scene by cueing a frame to start playback with high accuracy.

Along with widespread use of randomly accessible recording/reproducing devices such as hard disk drives (HDD), it has recently become possible to start playback of a broadcast program, once recorded, quickly from an arbitrary position within the program. Consequently, there comes out, for example, a video recording system that creates a list of start positions of all scenes constituting a broadcast program so that each scene can be played back from its beginning and allows a user to specify a desired scene from the list and start its playback.

In related art as described in Japanese Patent Application Laid-Open Publication No. 2005-235272, broadcast program start position information indicating a precise start position of a program is transmitted by broadcast waves for the purpose of performing playback of a scene accurately and quickly. At a receiver side, when a broadcast program is recorded, index information of a program start position corrected based on the above information is created and a position to start playback is determined using the index information when a scene is played back.

In a system of related art as disclosed in Japanese Patent Application Laid-Open Publication No. 2006-053876, broadcast station information (broadcast station code) that identifies a broadcast station and time stamp information (time code) that specifies time during which a broadcast program was recorded are used as information for specifying a position in a broadcast program once recorded. URL linked to this information is prepared as metadata beforehand. In this system, while watching a broadcast video from a recorded video file, the viewer can obtain more detailed information from a Web site on the Internet which is searched out based on the URL by one-touch action.

### SUMMARY OF THE INVENTION

After recording a broadcast program, when a user wants to start playback from a desired position in recorded program data, the following problem is posed: it is impossible to accurately specify a frame to start playback (hereinafter referred to as an “objective frame”) only based on the time stamp information (time code) described in the above-mentioned Japanese Patent Application Laid-Open Publication No. 2006-053876, due to different functions of video recoding devices and different broadcast areas.

First, conventional video recording devices do not always start recording exactly at a user-specified time to start recording. This is because, for example, video recording may be arranged to start several seconds earlier than the specified time to start in order to prevent missed recording at the beginning of a broadcast program. To broadcast video data recorded by a currently standard video recording system, precise time stamps of recording on a frame-by-frame basis are not attached. This makes it hard to specify the precise position of an objective frame in broadcast video data recorded only based on the time stamp information.

Consider a situation where a same broadcast program is recorded in different areas. In the case of a live broadcast, a break time (or position) of a station break spot (or a commercial message hereinafter abbreviated as “CM”) would be the same for the areas where the broadcast is received. However, in the case of a recorded broadcast, the CM break time might differ depending on the areas where the broadcast is received. As a result, time deviation of an objective frame in broadcast video data recorded by a user may occur and it may become hard to specify an object frame precisely.

According to the art described in the above-mentioned Japanese Patent Application Laid-Open Publication No. 2005-235272, a solution to this problem is provided. However, it is necessary that the broadcast station side transmits “broadcast program start position information” and the receiver side creates “index information”. Therefore, a contrivance only at the receiver side cannot solve the problem.

Furthermore, in digital broadcasting, video signals are encoded and transmitted and these signals are decoded at the receiving side. Due to time required for encoding and decoding, video of even a live broadcast program which is recorded or watched in real time involves a time delay depending on a signal transmission path, a relay method, etc. This time delay also makes it hard to specify the precise position of an objective frame in broadcast video data recorded.

In view of the above problems, the present invention allows a user to specify a precise position of an objective frame in recorded broadcast data and start playback from the objective frame, for example, by a contrivance only at the receiver side.

In a specific example, there is provided a broadcast program recording/playback apparatus that starts playback of a recorded broadcast program from a desired scene and the apparatus comprises a recording control unit that records received broadcast program data into a storage unit and a playback control unit that plays back recorded broadcast data retrieved from the storage unit. The playback control unit obtains information for feature data belonging to a referential feature frame and a relative time difference between the feature frame and an objective frame including the desired scene as position specifying data for determining the desired scene position. Then, the playback control unit searches for the feature frame having the feature data from recorded broadcast program data, determines the objective frame position by adding the relative time difference to the position of the feature frame searched out, and controls to start playback from the determined objective frame position.

The playback control unit may further obtain information for a reference time stamp at which the feature frame is estimated to be present and a search range around the reference time stamp as the position specifying data and may search for the feature frame having the feature data from the recorded broadcast data within the obtained search range.

The feature data may represent a caption, video, or audio characteristic that is uniquely distinguishable from other contiguous frames.

In another specific example, there is provided a broadcast program playback position control method that starts playback of a recorded broadcast program from a desired scene and the method obtains information for feature data belonging to a referential feature frame and a relative time difference between the feature frame and an objective frame including the desired scene as position specifying data for determining the desired scene position. Then, the method searches for the feature frame having the feature data from recorded broadcast program data, determines the objective frame position by adding the relative time difference to the position of the feature frame searched out, and starts playback from the determined objective frame position.

In a further specific example, there is provided a broadcast program information providing apparatus that provides position specifying data for determining the position of each of scenes of a broadcasted program to a broadcast program recording/playback apparatus. The broadcast program information providing apparatus comprises a PC for creating broadcast program information and a server for providing broadcast program information. The PC for creating broadcast program information divides a broadcasted program into a plurality of scenes and creates, as the position specifying data for each scene, feature data belonging to a feature frame, a reference time stamp at which the feature frame is estimated to be present, a search range for searching for the feature frame, and a relative time difference between the feature frame and an objective frame including the scene. The server for providing broadcast program information provides the created position specifying data to the broadcast program recording/playback apparatus via the Internet.

According to the above specific examples, a user can start playback precisely from a desired scene in a recorded broadcast program.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an embodiment of a broadcast program recording/playback system;

FIG. 2 shows an example of a broadcast program information screen provided by a server for providing broadcast program information;

FIG. 3 shows an example of a corner by corner information screen for a program provided by the server for providing broadcast program information;

FIG. 4 shows an example of position specifying data received from the server for providing broadcast program information;

FIG. 5 is a flowchart illustrating an embodiment of a processing procedure of a broadcast program playback position control method; and

FIG. 6 is a flowchart illustrating an example of a processing procedure when a broadcast program information provider entity creates position specifying data.

### DESCRIPTION OF THE EMBODIMENTS

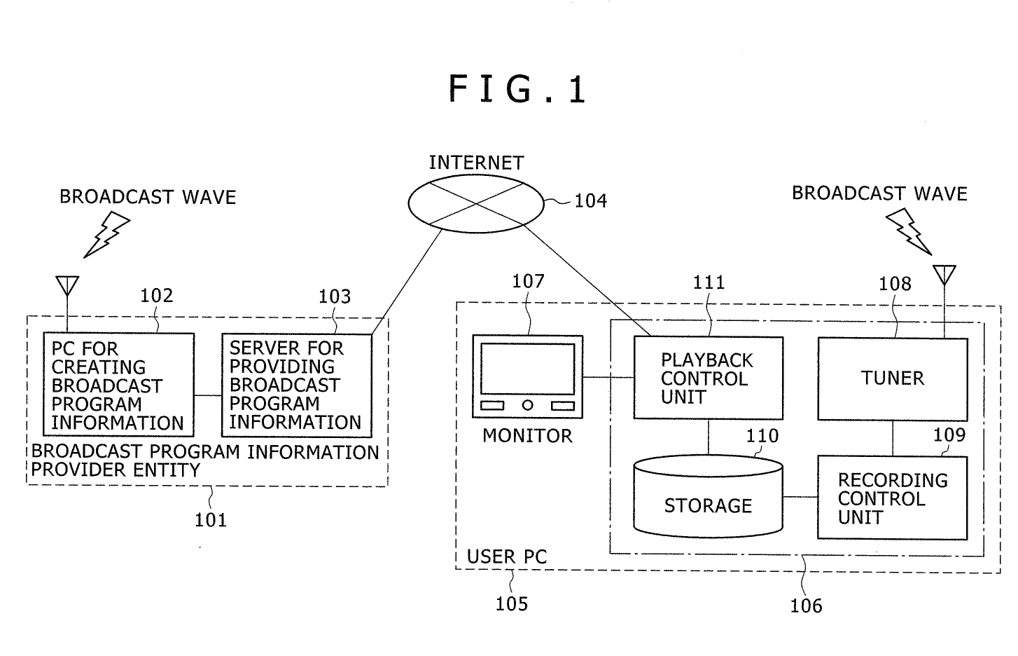

FIG. 1 is a block diagram showing an embodiment of a broadcast program recording/playback system. In this system, using broadcast program information that is provided by a broadcast program information provider entity 101, that is, position specifying data that specifies each of scenes in a broadcast program (hereinafter referred to as “corners” in units of topics and the like constituting the program), a playback is started from the beginning of a desired corner from broadcast program data recorded on a user PC 105.

The broadcast program information provider entity 101 is equipped with a PC 102 for creating broadcast program information and a server 103 for providing broadcast program information as a broadcast program information providing apparatus. The PC 102 for creating broadcast program information creates a set of position specifying data. The PC 102 for creating broadcast program information has functions of receiving, recording, and playing back a broadcast program and a broadcast program information creating program which is a computer program for creating broadcast program information is installed therein. A set of position specifying data created by the PC 102 for creating broadcast program information is released over the Internet 104 from the server 103 for providing broadcast program information.

A user is assumed to use the user PC 105 having recording and playback functions as a broadcast program recording/playback apparatus that receives and records a broadcast program. The PC with broadcast program recording and playback functions is a PC with a widely known configuration already available in the market. To apply the present system, software for recording and watching/listening to TV programs installed in the PC may be altered.

It is convenient to use a widely known Electronic Program Guide (EPG) when recording a broadcast program. Thereby, broadcast station information for identifying a broadcast station, broadcast start time representing time at which broadcast recording started, a program title obtained from the EPG, etc. can also be recorded, attached to broadcast video data recorded.

Functional blocks of a video recording and playback program operating on the user PC 105 are described. The video recording and playback program is executed on a user PC mainframe 106 which is the mainframe of the user PC 105. Video that is played back by the video recording and playback program is displayed on a monitor 107. This figure is drawn, focusing on only video recording and playback, and other parts are omitted.

A tuner 108 receives a broadcast program and a recording control unit 109 stores received video data into a storage 110. The storage 110 is, for example, a large-capacity hard disk storage device. The recording control unit 109 presents the obtained EPG to the user to allow the user to specify a broadcast program using the EPG.

The recording control unit 109 stores the video data of a broadcast program specified by the user into the storage 110 and, at the same time, may compute information needed for a later search for a feature frame. If, for example, video information is used as feature data, computing feature data in broadcast video simultaneously with recording it enables processing of computing a feature frame later to be executed at a higher speed. Computed feature data is stored together with video data into the storage 110. As feature data of broadcast video, data such as a color distribution across a screen of the video displayed, as will be described later, is used.

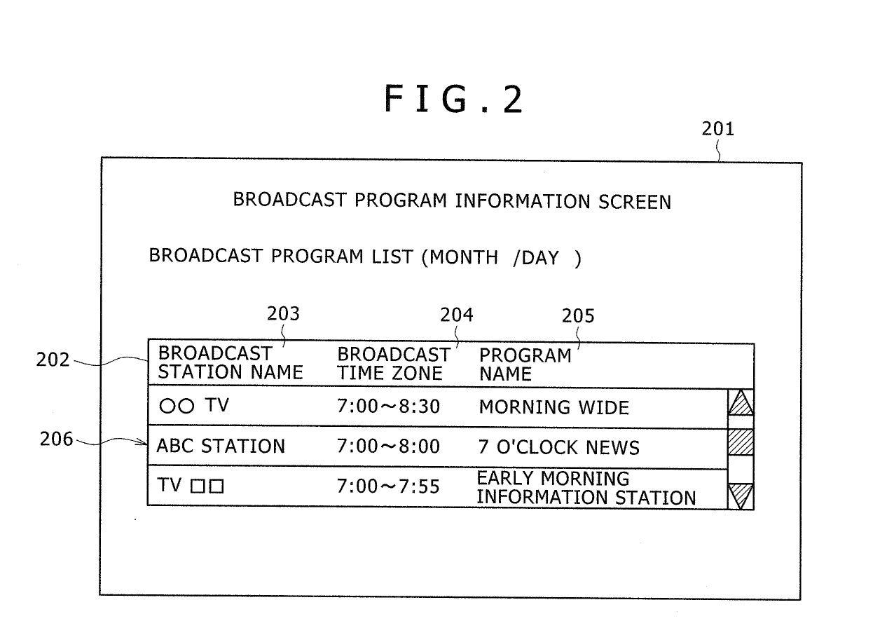

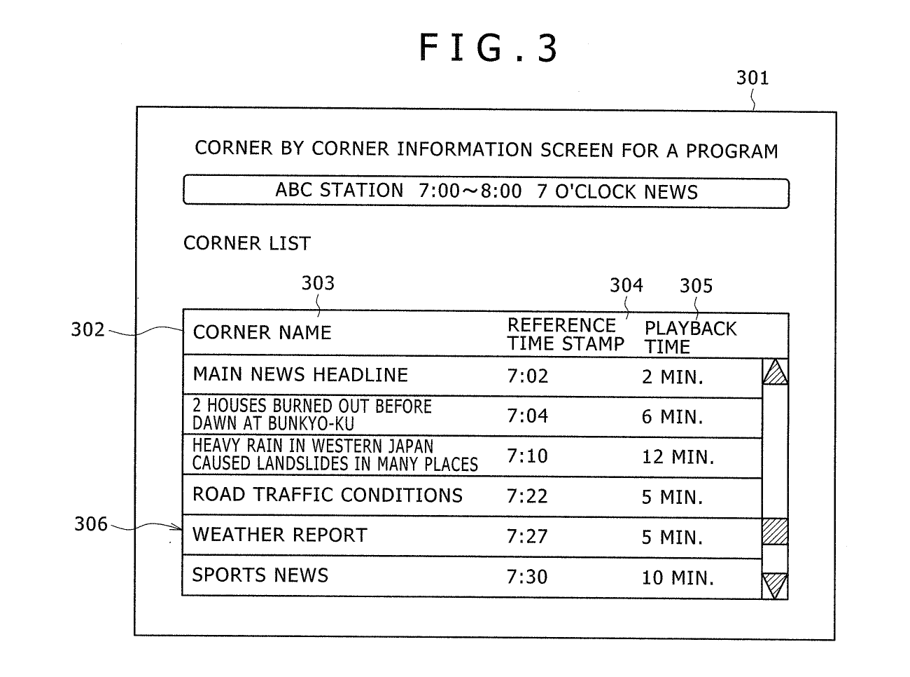

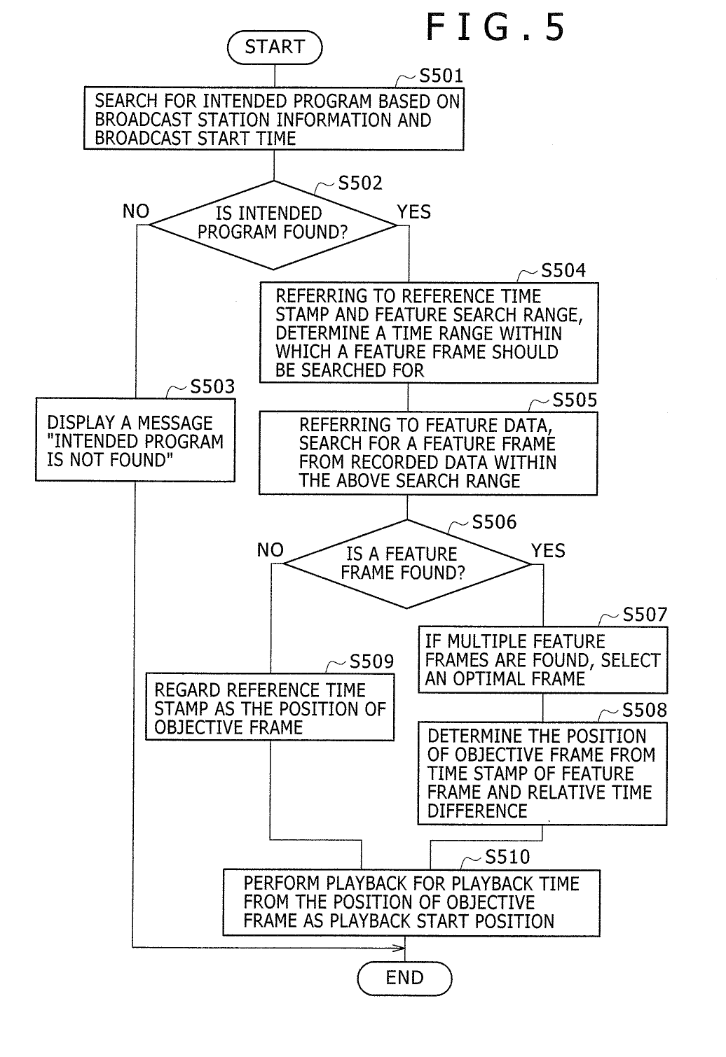

A playback control unit 111 connects to the server 103 for providing broadcast program information via the Internet 104 and obtains position specifying data for playing back a broadcast program. The playback control unit 111 presents to the user a broadcast program information screen 201 shown in FIG. 2 and a corner by corner information screen for a program 301 shown in FIG. 3, which will be described later, to allow the user to select a corner desired to be played back. The playback control unit 111 selects appropriate video data from the storage 110, based on the details of the position specifying data, and starts playback from a proper position. The operation of the playback control unit 111 after obtaining the position specifying data will be described later with reference to FIG. 5.

FIG. 2 shows an example of the broadcast program information screen 201 provided by the server 103 for providing broadcast program information of the broadcast program information provider entity 101. The user can view and interact with the broadcast program information screen 201 displayed on the monitor 107 of the user PC 105. A broadcast program list 202 that is a list of broadcast programs for which broadcast program information has been created is displayed on the broadcast program information screen 201. In this example, broadcast station name 203, broadcast time zone 204, and program name 205 information is presented to allow the user to specify a broadcast program. The user can select a broadcast program including a corner that the user wants to watch and listen to from the broadcast program list 202. In this figure, the user is assumed to have selected (clicked on) “7 o'clock news” broadcasted by “ABC station” (denoted by a reference numeral 206).

When the user selects a desired broadcast program, the following screen is provided from the server 103 for providing broadcast program information.

FIG. 3 shows an example of the corner by corner information screen for a program 301 provided by the server 103 for providing broadcast program information. A corner list 302 is displayed which is a time-sequential list of all corners of a broadcast program selected on the broadcast program information screen 201 in FIG. 2. Here, in particular, a corner list of a selected program “7 o'clock news” broadcasted by “ABC station” is shown. The corner list 302 contains information on corner name 303 of each corner, reference time stamp 304 indicating the start time of the corner, and playback time 305 taken to play back the corner. In this figure, the user is assumed to have selected (clicked on) “weather report” (denoted by a reference numeral 306).

When the user selects a desired corner, position specifying data is provided from the server 103 for providing broadcast program information. In order to precisely position an objective frame corresponding to the start position of the desired corner, the position specifying data describes the position of the objective frame by a time difference from a frame that is present near the objective frame and distinguishable from other frames by a visual feature or the like (this frame is hereinafter referred to as a “feature frame”). Information for determining the feature frame is termed “feature data”. In this way, a method of specifying the position of the objective frame by a time difference from the position of the feature frame is adopted in the present embodiment. Because the time difference is always constant without being affected by a start position of broadcast video recording and a CM break time, it does not happen that the position to start playback of a desired corner deviates due to different functions of video recoding devices and different broadcast areas.

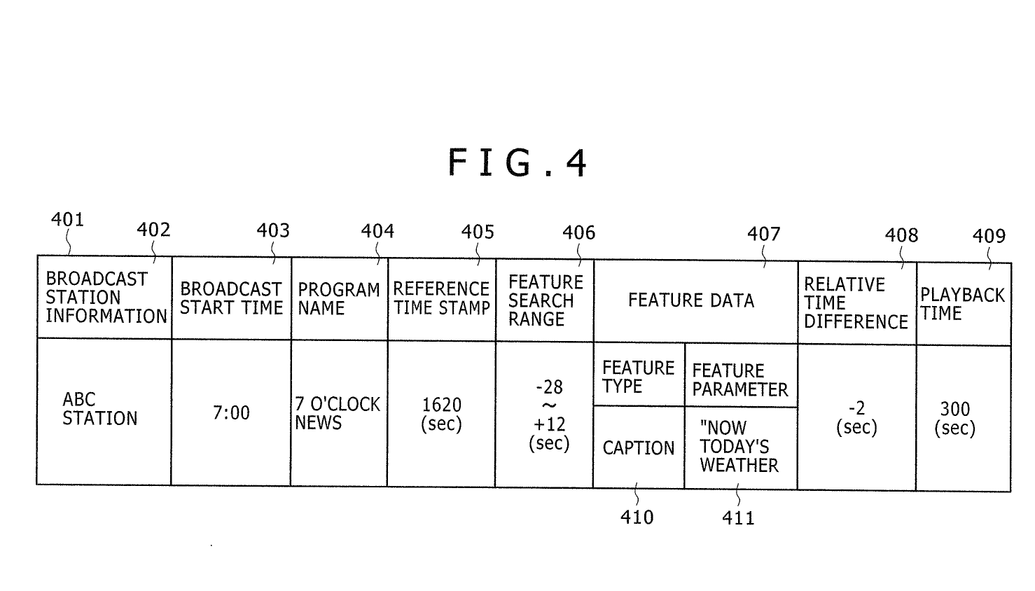

FIG. 4 shows an example of position specifying data 401 received by the user PC 105 from the server 103 for providing broadcast program information. The position specifying data 401 contains broadcast station information 402, broadcast start time 403, program name 404, reference time stamp 405, feature search range 406, feature data 407, relative time difference 408, and playback time 409.

Reference time stamp 405 corresponds to a position where an objective frame corresponding to the start position of the desired corner “weather report” exists (to be exact, a position estimated to be near the objective frame) and is information (time code) indicating time in seconds elapsed after the program start time until the objective frame has appeared. As already noted about the existing problems, however, a precise determination of the objective frame cannot be accomplished only based on the reference time stamp 405 due to a deviated start position of broadcast video recording depending on video recording device type, possible variation of CM break time, a time delay during broadcast signal transmission and reception, etc.

Feature search range 406 is a time range within which a feature frame should be searched for before and after the reference time stamp 405; that is, it specifies the seconds before the reference time stamp 405 and the seconds after the reference time stamp 405 and, within the range therebetween, a feature frame should be searched for. In the example of FIG. 4, the reference time stamp 405 is 1620 seconds (at the time of elapse of 27 minutes from the start of the broadcast program) and it is indicated that a feature frame should be searched for within a range between 28 seconds before the time stamp and 12 seconds after the time stamp.

Feature data 407 is information needed to determine the feature frame and consists of feature type 410 and feature parameter 411. In the example of FIG. 4, the feature type 410 is “caption” and the feature parameter 411 is letter strings “now, today's weather”. This means that a frame in which the caption “now, today's weather” first appears is determined as a feature frame.

Relative time difference 408 is information indicating the position of the objective frame in terms of seconds before or after the feature frame. In the example of FIG. 4, the relative time difference 408 is −2 and this means that the objective frame appears two seconds before the feature frame. Playback time 409 is literally a time taken to play back the corner, so the user will watch and listen to it. In the example of FIG. 4, the playback time 409 is 300 seconds, or five minutes.

Here, in the position specifying data 401 that is obtained by the user PC 105, different areas where potential users may live are taken into consideration. That is, if a user registers his or her residential area with the server 103 for providing broadcast program information beforehand, the server 103 for providing broadcast program information converts the broadcast station information 402 and the broadcast start time 403 included in the position specifying data 401 to the broadcast station information 402 and the broadcast start time 403 appropriate for the area and transmits the position specifying data 401. This scheme enables proper playback of a desired program and corner adaptively for, for example, a situation where a local broadcast station broadcasts a program broadcasted in Tokyo on a different day of the week and in a different time zone and changes a CM break time during the program. Even in this case, because the objective frame can be determined by a relative time difference from the feature frame, it is not needed to make an additional change to other components of the position specifying data 401.

When the user PC 105 receives the position specifying data 401 as described above from the server 103 for providing broadcast program information, it searches for a user-selected corner (an objective frame corresponding to the start of the corner) in a procedure which will be described below and starts playback from the objective frame. It is not necessary to display the received position specifying data 401 on the monitor 107.

FIG. 5 is a flowchart illustrating an embodiment of a processing procedure of a broadcast program playback position control method according to the present embodiment. In this flowchart, processing on the user PC 105 after obtaining the position specifying data 401 shown in FIG. 4 is explained.

The user PC 105 refers to the broadcast station information 402 and the broadcast start time 403 in the received position specifying data 401 and searches for an intended broadcast program from recorded broadcast data stored beforehand in the storage 110 (step 501). Because broadcast video data recorded by the user PC 105 is attached with broadcast station information and broadcast start time, as indicated above, the intended broadcast program can easily be identified from the recorded broadcast data by comparing the broadcast station information 402 and the broadcast start time 403 included in the position specifying data 401 for match with those attached to broadcast video data. As a result of the search, it is determined whether the intended broadcast program is found (step 502). If the intended broadcast program is not found in the storage 110, a message indicating it is displayed on the monitor and the processing terminates (step 503). Upon the termination of the processing, the screen for selecting a broadcast program as shown in FIG. 2 appears again on the monitor.

If the intended broadcast program is found, as determined at step 502, the user PC refers to the reference time stamp 405 and the feature search range 406 in the position specifying data 401 and determines a range within which a feature frame is searched for in the recorded broadcast data (step 504). According to the example of FIG. 4, since the reference time stamp 405 is 1620 seconds and the feature search range 406 is from −28 to +12 seconds, the range within which the feature frame should be searched for is between 1592 seconds and 1632 seconds.

Then, the user PC refers to the feature data 407 in the position specifying data 401 and searches for a feature frame from the recorded broadcast data within the search range determined at step 504 (step 505). Specifically, the PC scans the recorded broadcast data from the starting position of the feature search range and, from among sequential frames therefrom, searches for a frame matching with the feature data 407. The PC terminates the search at the end position of the feature search range. In the case of the position specifying data 401 of FIG. 4, because the feature type 410 is “caption”, it is reasonable to check each frame in the search range as to whether the letter strings “now, today's weather” as the feature parameter 111 begin in the frame.

It is determined whether a feature frame has been searched out (step 506). As a result of the feature frame search, if there are multiple frames matching with the feature data, as determined at step 506, an optimal frame is selected as a feature frame from these candidates (step 507). Although the determination is relatively explicit if the feature type 510 is caption, in the case multiple candidates are found, it is reasonable to select one of the candidates which is nearest to the reference time stamp 405. If the feature type 410 is “audio” or “video”, it is reasonable to select a frame having a feature closest to the feature parameter 411 as the feature frame.

Once a feature frame has been determined, the position of the objective frame can be determined by adding a relative time difference 408 to the time of the feature frame (step 508). For example, given that the position of the feature frame (in terms of time elapsed from the head of the recorded broadcast data) is 1596 seconds, the position of the objective frame is calculated to be 1594 seconds because the relative time difference 408 is −2.

If no feature frame has been searched out, as determined at step 506, the user PC continues the processing, regarding the reference time stamp 405 as the objective frame (step 509).

The user PC 105 sets the determined position of the object frame (the position corresponding to 1594 seconds from the head of the recorded broadcast data in this case) as the position to start playback and executes playback for a duration specified by the playback time 409 (for 300 seconds in this case). Upon the termination of the playback, the user PC 105 displays again the screen for selecting a corner in a program, the screen like the example shown in FIG. 3 in this case.

In this way, in the present embodiment, the position of the objective frame is specified with a relative time difference from the position of the feature frame. The feature frame can easily be determined because of having a feature that is uniquely distinguishable from other contiguous frames. Consequently, the position to start the playback of a desired corner can be specified precisely.

In the present embodiment, as the feature data 407 that specifies the feature frame, the timing of appearance of a specific caption is used. However, a feature frame can be determined in other manners such as: extracting a video feature and determining a scene changeover frame; and extracting an audio feature (a position in which, e.g., a “beep” sound appears) and determining a feature frame.

In the case where a video feature is used to determine a feature frame, such a method is available that consists of dividing a screen into a certain number of blocks, averaging the color values of pixels contained in each block, and applying a set of color values averaged per block as a feature parameter. For example, if the screen is partitioned by four vertical and horizontal lines which are equally spaced, the screen is divided into 16 blocks and a set of color vectors for the 16 blocks is used as a feature parameter. Color distribution across these blocks changes successively when frames of a same scene continue. However, the color distribution changes significantly when the scene is changed to another one. By detecting this change, a scene changeover position can be detected. One or more frames that are present in the scene changeover position can be feature frame candidates. Among the candidates, it is reasonable to determine one that has a color distribution closest to a given feature parameter as the feature frame.

In the case of using audio as the feature data, it is reasonable to set an audio waveform having a certain period following a silent duration which continues for a certain period or longer as the feature parameter. When searching for a feature frame, it is reasonable to first search for the silent duration which continues for a certain period or longer, compare an audio waveform following the silent duration with the audio waveform given as the feature parameter, and determine whether there is a match between both. If both waveforms match sufficiently, the frame involving the above audio waveform can be determined as the feature frame.

Next, how the broadcast program information provider entity 101 creates broadcast program information, or namely, position specifying data 401 that is provided to users, is explained.

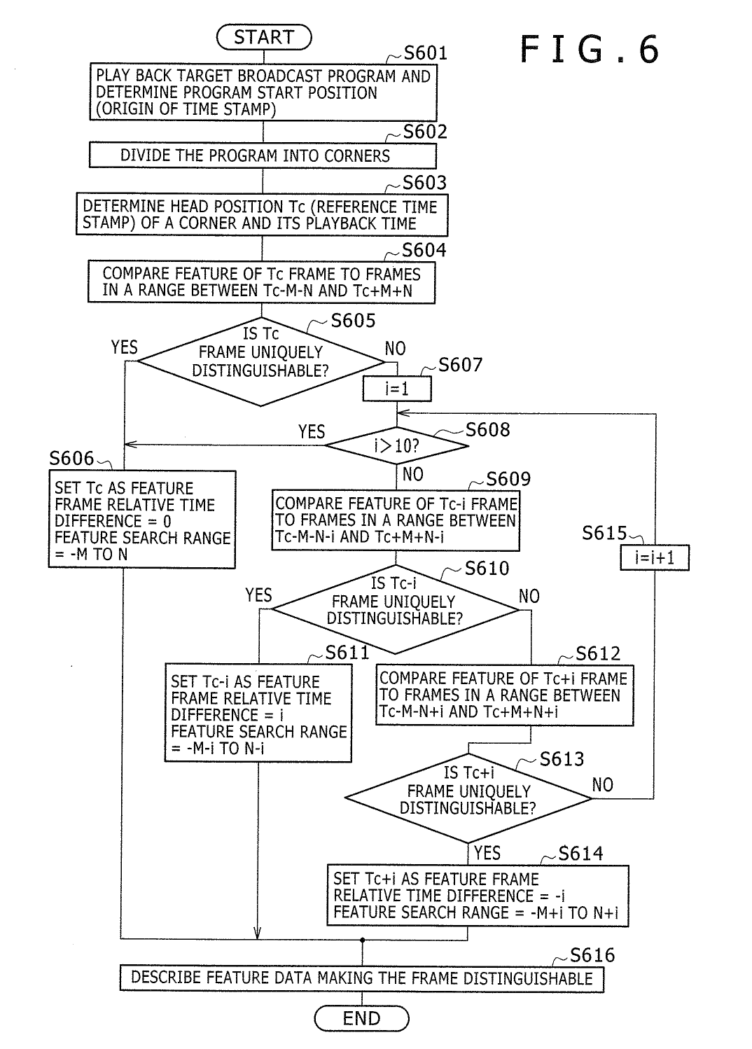

FIG. 6 is a flowchart illustrating an example of a processing procedure when the broadcast program information provider entity 101 (the operator of the server 103 for providing broadcast program information or a party who operates the server, outsourced by the operator) divides a broadcast program into corners and creates the position specifying data 401 shown in FIG. 4 for each corner. A special program for creating the broadcast program information (hereinafter referred to as a “broadcast program information creating program”) is installed in the PC 102 for creating broadcast program information of the broadcast program information provider entity 101 and the processing which will be described below is performed using this program.

First, the PC 102 for creating broadcast program information receives broadcasted programs and records them into the storage unit. The broadcast program information creator plays back recorded broadcast data retrieved from the storage unit and searches for a target broadcast program for which broadcast program information is created. To the beginning of each broadcast program, video data for several seconds may be added before the start of the program in order to prevent missed recording at the beginning of the program. Therefore, the broadcast program information creator looks for an instant at which, for example, a program title appears, determines this instant as a precise starting position of the broadcast program, and sets the instant to be the origin for calculating reference time stamps (hereinafter referred to as the “origin of time stamp”)(step 601).

The broadcast program information creator starts to watch and listen to video and audio in the broadcast program and divides one program into a plurality of corners according to topics and news items by repeating operations such as fast-forwarding, rewinding, and pausing. The creator enters the title of each corner and related comments and marks the head position and the end position of each corner (step 602).

The creator describes the head position and the end position of each corner in terms of time elapsed from the origin of time stamp. From the elapsed time indicating the head position of the corner, the creator determines the reference time stamp 405 in the position specifying data 401 shown in FIG. 4. From the time from the corner head position to the end position, the creator determines the playback time 409 in the position specifying data 401 (step 603).

Then, the PC enters a process of generating (extracting) feature data 407 for determining the head position of the corner and determining the feature search range 406. In explaining this process, the corner head position is denoted by Tc and the feature frame position is denoted by Ta. The corner head position Tc is given as the reference time stamp 405 in the position specifying data 401. For example, if the weather report corner starts at 52 minutes after the origin of time stamp at which the broadcast program starts, Tc or the reference time stamp 405 is 27×60=1620 seconds. In the present embodiment, it is assumed that there is one video frame for every second to simplify explanation.

However, in the recorded broadcast data stored in the user PC 105, the corner head position Tc may not coincide with the reference time stamp 405 and may appear at a maximum of M seconds earlier than or at a maximum of N seconds later than the reference time stamp 405. For example, a CM break time may be up to 30 seconds shorter depending on the areas where the broadcast is received. Furthermore, another video data for up to 10 seconds may be added to the corner head position to prevent missed recording at the beginning when video recording starts and due to a time delay during broadcast transmission and reception. In such cases, it is assumed that M=30 and N=10. That is, under these conditions, in the broadcast data recorded by the user PC 105, the position Tc where the objective frame appears may vary in a range from M=30 seconds earlier than to N=10 seconds later than the reference time stamp 405 (1620 seconds). The width of this range is M+N=40 seconds and feature data 407 is generated (extracted), taking account of this range (M+N) in which Tc is variable.

First, the frame of the corner head position Tc is compared to other frames to determine whether it has a uniquely distinguishable feature. The range of the comparison is (M+N) seconds (frames) before and after Tc, that is, the Tc frame feature is compared to each frame falling within the range between Tc−M−N and Tc+M+N (step 604). It is determined whether the Tc frame is uniquely distinguishable (step 605). If it is distinguishable, the Tc frame itself is determined to be the feature frame. In that case, the relative time difference 408 is set to 0, because the feature frame position Ta is equal to the corner top position Tc, and the feature search range 406 is set to −M to +N, that is, −30 to +10 in this example, because it is the same as the range in which Tc may appear in the recorded broadcast data (step 606). Once the feature frame has been determined, feature specifics making the frame distinguishable are extracted and described as feature data 407 (feature type 410 and feature parameter 411) in the position specifying data 401 (step 616).

If the frame of the corner top position Tc is not uniquely distinguishable, as determined at step 605, frames before and after Tc are checked as to whether it can be a feature frame. That is, i is assumed to be 1 (step 607) and a Tc−i frame or Tc+i frame is compared to other frames to determine whether it can be a feature frame. At this time, the comparison range to determine whether the Tc−i frame is uniquely identifiable is from Tc−M−N−i to Tc+M+N−i (step 609). The comparison range to determine whether the Tc+i frame is uniquely identifiable is from Tc−M−N+i to Tc+M+N+i (step 612). If Tc−i is determined to be the feature frame, the relative time difference 408 is set to i and the feature search range 407 is set to −M −i to +N−i in the position specifying data 401 (step 611). If Tc+i is determined to be the feature frame, the relative time difference 408 is set to −i and the feature search range 407 is set to −M+i to +N+i in the position specifying data 401 (step 614). If both Tc−i and Tc+i cannot be a feature frame, i is incremented by one (step 615) up to a predetermined value (e.g., 10) and frames are checked as to whether it can be determined as a feature frame. If a feature frame cannot determined even if i has been incremented to the predetermined value (Yes at step 608), Tc itself is used as the feature frame (step 606). In either case, once the feature frame has been determined, feature specifics making the frame distinguishable are extracted and described as feature data 407 (feature type 410 and feature parameter 411) in the position specifying data 401 (step 616). Then, the process for creating the position specifying data 401 terminates.

The example of FIG. 4 is an instance where a uniquely distinguishable feature, that is, the caption “now, today's weather” appears in a Tc+2 frame in the range from Tc−M−N+2 to Tc+M+N+2. In this case, feature data 407 is generated in which the feature type 410 is “caption” and the feature parameter 411 is letter strings “now, today's weather”, and the feature search range 406 is set to −28 to +12 and the relative time difference 408 is set to −2.

In the broadcast program recording/playback system according to the present embodiment, it becomes possible to precisely specify the position of a user-desired corner even with different video recording devices and even for broadcast data recorded in different areas. To accomplish this, the broadcast program information provider entity provides information effective for specifying a position in broadcast video data to an undefined number of users in different environments. Furthermore, an effective form of position specifying information is, for example, such that annotation is attached to a specific position in broadcast video data and it is released over the Internet.

While the PC with video recording functions is used as the broadcast program recording/playback apparatus in the present invention, needless to say, the recording/playback apparatus is not limited to such PC. An HDD recorder and a TV receiver incorporating video recording functions in which recording and playback can be externally controlled may be used. In that case, the user obtains the position specifying data 401 from the server 103 for providing broadcast program information, using a PC, game console, or the like that can get information via the Internet 104 in FIG. 1, and sends that data to the externally controllable HDD recorder or TV receiver incorporating video recording functions. The HDD recorder or TV receiver incorporating video recording functions interprets the position specifying data 401 and starts playback of recorded broadcast data from a specified position. Alternatively, the HDD recorder or TV receiver incorporating video recording functions may be adapted to be able to get information directly from the server 103 for providing broadcast program information via the Internet 104.

What is claimed is:

1. A broadcast program recording/playback apparatus that starts playback of a recorded broadcast program from a desired scene, comprising:
a recording control unit that records received broadcast program data into a storage unit; and
a playback control unit that plays back recorded broadcast data retrieved from the storage unit,
wherein: the playback control unit obtains information for feature data belonging to a referential feature frame and a relative time difference between the feature frame and an objective frame including the desired scene as position specifying data for determining the desired scene position;
searches for the feature frame having the feature data from recorded broadcast program data;
determines the objective frame position by adding the relative time difference to the position of the feature frame searched out; and
controls to start playback from the determined objective frame position.

2. The broadcast program recording/playback apparatus according to claim 1,
wherein: the playback control unit further obtains information for a reference time stamp at which the feature frame is estimated to be present and a search range around the reference time stamp as the position specifying data; and
searches for the feature frame having the feature data from the recorded broadcast data within the obtained search range.

3. The broadcast program recording/playback apparatus according to claim 1,
wherein: the feature data represents a caption, video, or audio characteristic that is uniquely distinguishable from other contiguous frames.

4. The broadcast program recording/playback apparatus according to claim 1,
wherein: the position specifying data is the data created by a broadcast program information provider based on broadcasted programs and released from the broadcast program information provider; and
the playback control unit obtains the position specifying data via the Internet.

5. A broadcast program playback position control method that starts playback of a recorded broadcast program from a desired scene, comprising the steps of:
obtaining information for feature data belonging to a referential feature frame and a relative time difference between the feature frame and an objective frame including the desired scene as position specifying data for determining the desired scene position;
searching for the feature frame having the feature data from recorded broadcast program data;
determining the objective frame position by adding the relative time difference to the position of the feature frame searched out; and
starting playback from the determined objective frame position.

6. The broadcast program playback position control method according to claim 5, further comprising the steps of:
further obtaining information for a reference time stamp at which the feature frame is estimated to be present and a search range around the reference time stamp as the position specifying data; and
searching for the feature frame having the feature data from the recorded broadcast data within the obtained search range.

7. The broadcast program playback position control method according to claim 5,
wherein the feature data represents a caption, video, or audio characteristic that is uniquely distinguishable from other contiguous frames.

8. The broadcast program playback position control method according to claim 5,
wherein the position specifying data is the data created by a broadcast program information provider based on broadcasted programs and released from the broadcast program information provider.

9. A broadcast program information providing apparatus that provides position specifying data for determining the position of each of scenes of a broadcasted program to a broadcast program recording/playback apparatus, the broadcast program information providing apparatus comprising:
a PC for creating broadcast program information and a server for providing broadcast program information, wherein:
the PC for creating broadcast program information divides a broadcasted program into a plurality of scenes and creates, as the position specifying data for each scene, feature data belonging to a feature frame, a reference time stamp at which the feature frame is estimated to be present, a search range for searching for the feature frame, and a relative time difference between the feature frame and an objective frame including the scene; and
the server for providing broadcast program information provides the created position specifying data to the broadcast program recording/playback apparatus via the Internet.

10. The broadcast program information providing apparatus according to claim 9,
wherein the feature data represents a caption, video, or audio characteristic that is uniquely distinguishable from other contiguous frames.
